(19) United States
(12) Patent Application Publication
(10) Pub. No.: US 2003/0193000 A1
(43) Pub. Date: Oct. 16, 2003

(54) Stabilising support device

(76) Inventor: Andrew Leveridge, Norwich (GB)

Correspondence Address: ORUM & ROTH, 53 W. JACKSON BLVD, CHICAGO, IL, 60604, US

(21) Appl. No.: 10/123,348

(22) Filed: Apr. 16, 2002

(51) Int. Cl. F16M 11/24

(52) U.S. Cl. 248/188.2

(57) ABSTRACT

A device (100) for stabilising a structure has a plurality of support members (101, 102), adjustable in length. At least one pair of support members (101, 102) is connected together by linkages (105, 106), which are operable to releasably engage a locking means (107) to adjust the relative effective length of the support members (101, 102).

Each support member (101, 102) is moveable along its longitudinal axis to change the effective length of the support member (101, 102). Linkages (105, 106) between support members (101, 102) can be operable by mechanical or fluid means. The locking means (107) can be actuated by upward pressure on a support member (101, 102).

The device (100) can be used to stabilise structures as diverse as a step ladder or an oil rig, and can be integral with or fitted to the structure.

### FIELD OF INVENTION

The invention relates to a device for stabilising objects or structures, particularly where the surface supporting the object or structure is sloping and/or uneven.

### BACKGROUND TO THE INVENTION

The use of support legs to support an object or structure is well known for example with ladders and walking frames, as well as for larger structures such as oil rigs. There are however problems inherent with using such support legs, in that the object or structure is unstable and/or can lean over when the ground on which each of the support legs rests is not at the same height. The user of the object or structure is then at risk or lacks confidence in its use.

The problem of a sloping and/or an uneven surface under the leg of a ladder can often be solved by simply placing a prop such as a brick or a piece of wood under one of the legs. As well as being potentially dangerous however, this action is also inconvenient in that the prop must be carried along with the ladder. Where the slope of the ground on which the ladder is to be used varies from place to place, the thickness of the prop may not be suitable. Furthermore, such a method is not always appropriate for use where larger structures such as oil rigs are concerned.

The above disadvantages have been appreciated by ladder users for many years and a number of devices have been devised to support or increase the overall footprint of a ladder to impart greater stability. In most instances these devices have been cumbersome and disproportionately expensive with respect to the ladder or target support structure.

It is an object of the present invention to provide a de-mountable device which when operatively linked to an object or structure stabilises and maintains the object or structure on sloping and/or uneven ground.

It is a further object of the present invention to provide an object and/or structure having a stabilising mechanism integrally associated therewith, to enable the structure to rest stabily on a sloping and/or uneven surface.

### SUMMARY OF THE INVENTION

According to the invention, there is provided a device for stabilising a structure, the device comprising a plurality of support members, adjustable in length, wherein at least one pair of support members is connected together by linkages which are operable to releasably engage a locking means to adjust the relative effective length of the support members.

Each support member is preferably moveable along longitudinal axis to alter its effective length. Advantageously, each pair of connected support members is so connected that motion of one member of the pair along its longitudinal axis to reduce/increase its effective length, causes corresponding motion of the other member to respectively increase/reduce its effective length.

The or each linkage preferably comprises one or more pivotally linked arms.

The linkages are optionally fluid-linkages comprising ducts carrying a locking means-engaging fluid.

The locking means is preferably actuated by upward pressure on a support member.

The locking means preferably comprises an elongate member and a locking member slidably mounted about the elongate member to engage releasably the elongate member and prevent further sliding motion. Engagement of the locking member conveniently causes a frictional force between the locking member and the elongate member to prevent the sliding.

The elongate member is preferably a rod, the rod conveniently having a circular cross-section.

Frictional engagement between the locking member and the elongate member is advantageously caused by rotation of the locking member about an angle substantially perpendicular to that of the elongate member, the force causing rotation being applied by the linkages.

The locking member conveniently comprises a hole through which the elongate member passes, the hole having a cross-section substantially complementary to that of the elongate member. The longitudinal axis of the hole is advantageously non-parallel with the longitudinal axis of the elongate member.

The connection means are advantageously coupled by a tensioning member, which biases the connection means to resist frictional engagement between the locking means and the elongate member.

The apparatus further advantageously comprises a second locking member operable to fix releasably the support members.

The locking means optionally comprises one or more independent valves each operable to prevent the flow of hydraulic fluid within each fluid linkages.

The locking means advantageously comprises two valves. The valves preferably move from an open position to a closed position when the pressure of the hydraulic fluid within the connection means reaches a pre-set value. The pre-set value is conveniently governed by a resilient member biased towards keeping the valve open. The resilient member is optionally a spring.

The apparatus optionally comprises an override mechanism operable to prevent the locking means from operating.

The invention includes within its scope apparatus comprising a device as herein described. The device is optionally integral with the apparatus.

### BRIEF DESCRIPTION OF THE DRAWING

The present invention will now be described more particularly with reference to accompanying drawings which show by way of example only, three embodiments of stabilising apparatus according to the invention. In the drawings:

FIGS. 1 to 6 illustrate schematically the operation of the stabilising system;

FIG. 7 is a detailed front view of a connection mechanism between two support legs of a first embodiment of stabilising mechanism;

FIG. 8 is a detailed top view of an embodiment of a locking mechanism;

FIG. 8a is a further detailed top view of an embodiment of a locking mechanism;

FIG. 9 is a detailed section through of a mechanical locking mechanism of a second embodiment of a stabilising mechanism;

FIG. 10 is a front elevation of a third embodiment of stabilising mechanism incorporating a hydraulic locking mechanism;

FIG. 11 is a schematic cross-sectional elevation of a hydraulic locking mechanism;

FIGS. 12 to 15 are elevations similar to that shown in FIG. 11 showing the operation of the hydraulic locking mechanism shown in FIG. 11.

### DETAILED DESCRIPTION OF THE INVENTION

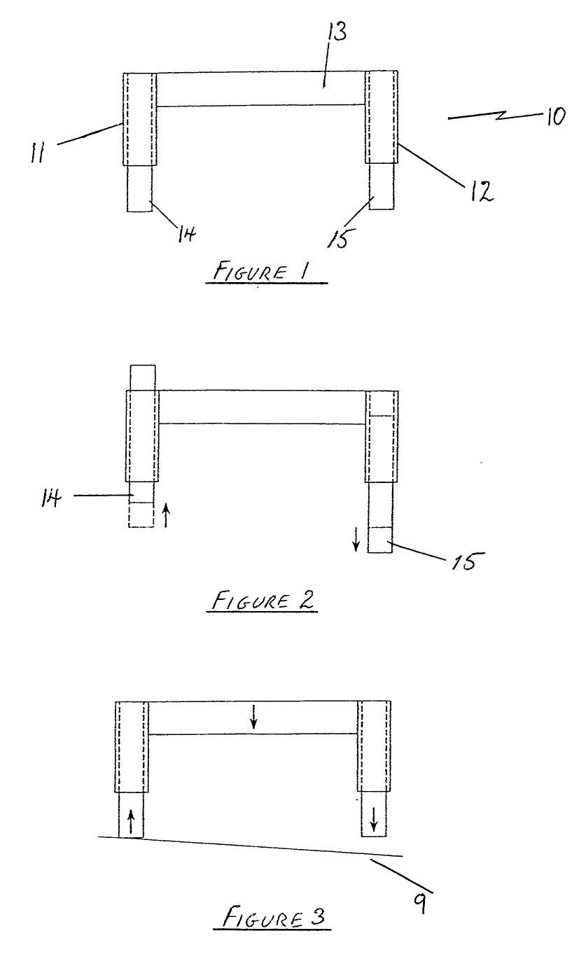

Referring to FIGS. 1 to 6, these show the operation of the stabilising device in general terms. Turning firstly to FIG. 1, the device 10 comprises two tubular members 11, 12 held in spaced relationship by the cross piece 13. The support legs 14, 15 are slidably housed in the tubular members 11, 12. As shown in FIG. 2, the support legs 14, 15 are operatively linked together such that upward motion of support leg 14 causes a corresponding downward motion of support leg 15.

In FIG. 3 the device 10 is lowered onto a sloping surface 9 such that support leg 14 contacts the surface before the support leg 15. Lowering of the device 10 continues until both of the support legs 14, 15 are in contact with the surface 9. Once this contact of both the support legs 14, 15 is established, a slight downward force (illustrated by arrow A in FIGS. 4 and 5) causing a locking mechanism (described below) to lock the support legs 14, 15 in this position.

As long as a downward force A is applied, even if the device 10 is tipped as illustrated by the arrow B in FIG. 5, the locking mechanism will remain operative. Once the downward force A is removed then the locking mechanism is released by application of an upward force (as illustrated by arrow C in FIG. 6) which removes the load from both of the legs 14, 15 leaving them free to move.

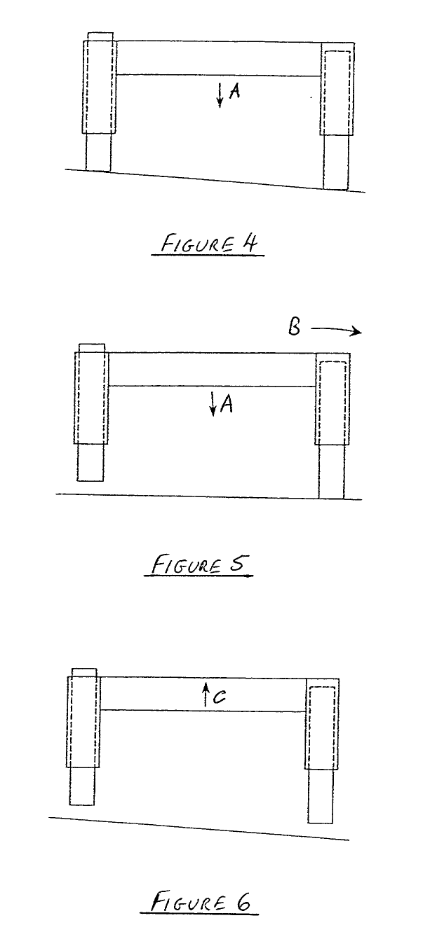

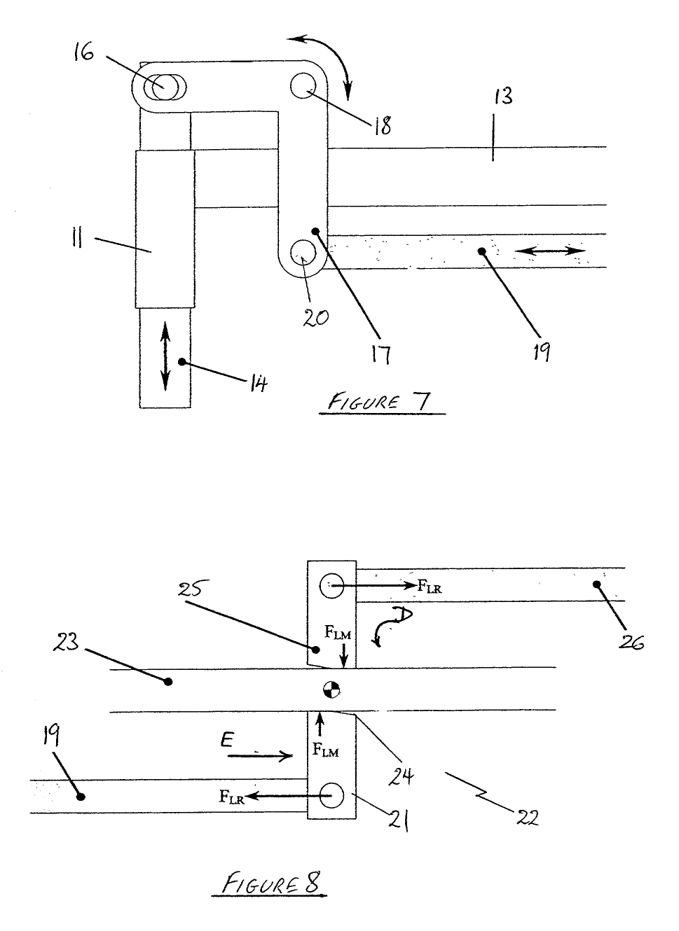

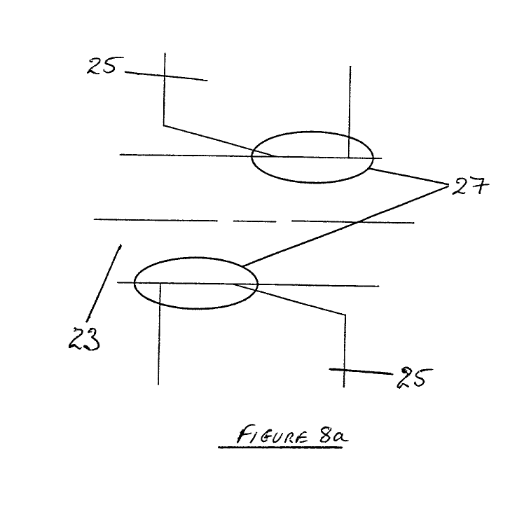

An embodiment of a locking mechanism is shown in FIGS. 7 and 8. In FIG. 7 a support leg 14 housed within tubular member 11 has a pivot point 16 to rotatably house a first end of an ‘L’ shaped crank arm 17. The crank arm 17 is pivotally mounted to pivot point 18, located on a side arm (not illustrated) of cross piece 13. A second end of the crank arm 17 is pivotally linked at a first end to a link rod 19 at pivot point 20. The second end of the link rod 19 is linked to the first end of a rotatable arm 21 of a locking mechanism generally referenced 22.

The locking mechanism 22 comprises a central locking rod 23. A locking element 25 comprises a hole 24 throughout its length. The hole 24 is substantially cylindrical with the central longitudinal axis of the hole 24 being offset from the lateral axis of the locking element 25 by 10 degrees. Furthermore, the mouths of the hole 24 are widened by drilling a second hole parallel to the lateral axis of the locking element 25. The second drilled hole provides a surface 27 of much greater area to contact the locking rod 23 than a singly drilled hole as is illustrated in FIG. 8a.

In use, the device can be attached for example, to a base of a ladder by attachment means (not illustrated). Alternatively, it may be incorporated as part of the ladder itself. When the ladder is to be used on a sloping surface such that the part of the surface on which one leg rests is lower than that which the other leg rests, the device 10 acts to maintain the ladder in the required orientation.

On placing the device 10 on the surface, the operator brings the device 10 down with the support legs 14, 15 substantially upright. The force acting on the first support leg 14 to encounter the surface 9 slides the support leg 14 through the tube 11. The force from the surface 9 acts through the crank arm 17 and the link rod 19 and is converted into a rotational force and a lateral force acting on the locking element 25. The rotational force causes rotation of the locking element 25 in direction D indicated in FIG. 8, and due to the nature of the axis of the hole 24, acts to maintain a spaced relationship between the walls of the hole 24 and the locking rod 23. The lateral force exerted by the crank arm 17 and the link rod 19 causes lateral motion of the locking element 25 along locking rod 23 in a direction indicated by arrow E in FIG. 8. The lateral motion of the locking element 25 is transmitted to support leg 15 through link rod 26 and a second crank arm (not illustrated), the link rod 26 and the second crank arm being linked into the support leg 15 in a corresponding manner to crank arm 17 and link rod 19.

The support leg 15 is thus caused to slide through tube 12 in a downward direction. The operator continues to move the device 10 in a downward direction until the support leg 15 engages the surface 9. On engagement of the support leg 15 with the surface 9, the upward force through the second crank arm and the link rod 26 exerts a pulling force as indicated by F_{LR} in FIG. 8. The force F_{LR} causes rotation of the locking element 25 in the opposite direction to that indicated by arrow D. Because of the offset relationship of the axis of the hole 24 to the axis of the locking rod 23, the locking element 25 frictionally engages the locking rod 23, preventing lateral motion of the locking element 25. The relative positions of the support legs 14, 15 are thereby fixed.

In an alternative embodiment, not illustrated, the link rods may be so linked to the locking element that the locking element is brought into frictional engagement with the locking rod by the link rods pushing on the locking element. In this embodiment a force in the direction F_{LR} would act to release the locking element from frictional engagement with the locking rod. This mode of action can for example be achieved by orienting the longitudinal axis of the hole as, illustrated in FIG. 8, such that the force F_{LR} brings it into parallel relationship with the cylindrical rod.

The locking rod can have a cross-section other than one which is circular. For example, a square or rectangular cross-section can be contemplated. In this case the locking element will have a corresponding shaped hole to engage the rod efficiently.

A tensioning member such as a spring can be incorporated which biasses the link rods to act on the locking element to maintain a spaced relationship between the walls of the hole and the locking rod.

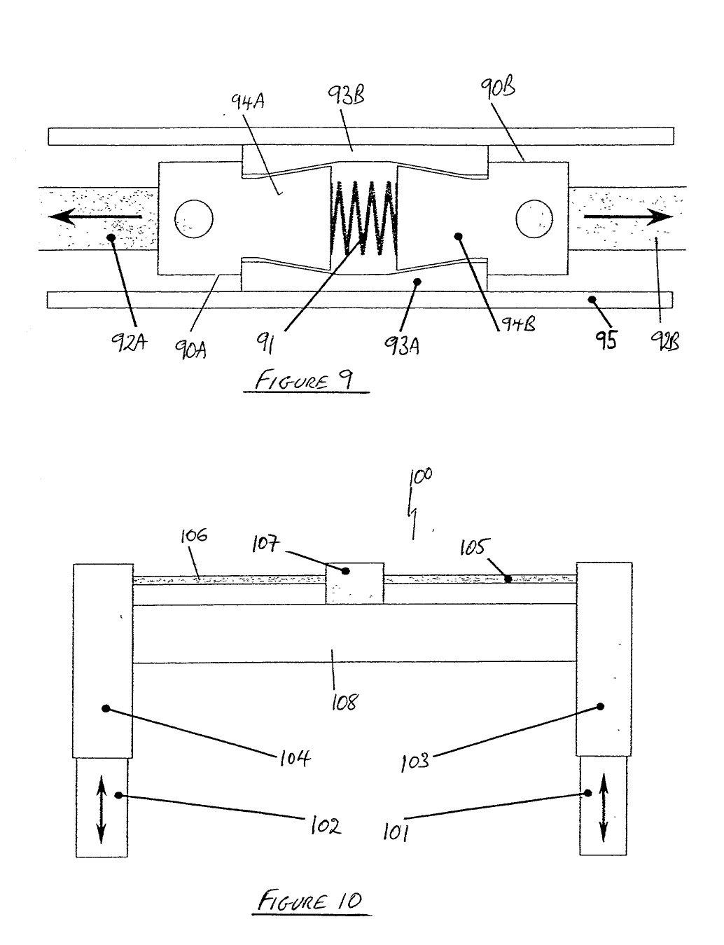

In FIG. 9 an alternative embodiment of a locking mechanism is illustrated. The locking mechanism comprises two expanders 90A, 90B held together by means of a spring 91. Each expander 90A, 90B is further attached to a link rod 92A, 92B. The locking mechanism further comprises friction pads 93A, 93B lying in contiguous relationship with the walls of a hollow rod 95. Each expander 90A, 90B comprises a frusto-conical portion 94A, 94B. The portions 94A, 94B are seated between the friction pads 93A, 93B which have a shape complementary to those of the frusto-conical portions 94A, 94B of the expanders 90A, 90B.

Upon application of force to the link rods 92A, 92B in the directions shown by the arrows in FIG. 9,—the force is being applied to the link rods 92A, 92B in a similar fashion to that illustrated for the link rods in FIGS. 7 and 8,—the force overcomes the tension exerted by the spring 91 and acts to separate the expanders 90A, 90B from one another. Separation is arrested due to the shapes of the expanders 90A, 90B and the friction pads 93A, 93B which convert the lateral forces exerted on the link rods 92A, 92B into a force which pushes the expanders 90A, 90B and in friction pads 93A, 93B, against the wall of the hollow rod 95. The resulting frictional force between the friction pads 93A, 93B and the wall of the hollow rod 95 is sufficiently great to prevent lateral movement due to the lateral forces. The legs to which the link rods 92A, 92B are attached are therefore unable to move and are effectively fixed in position. Furthermore, if tension in one of the link rods 92A, 92B is reduced the locking effect on the legs is not removed as long as a lateral force is maintained on the other link rod.

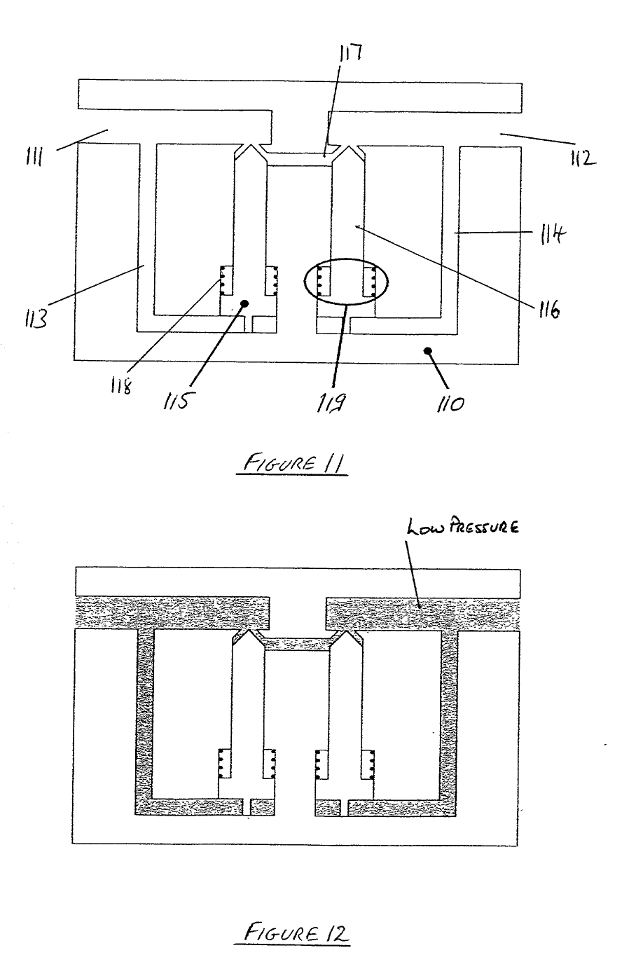

FIG. 10 illustrates a stabilising device 100 having a hydraulic locking mechanism. The device 100 comprises two ground engaging piston rods 101, 102 housed respectively within hydraulic cylinders 103 and 104. The interior of each of the hydraulic cylinders 103, 104 is connected by means of hydraulic lines 105, 106 to a valve block 107. The valve block 107 is supported on supporting cross-member 108.

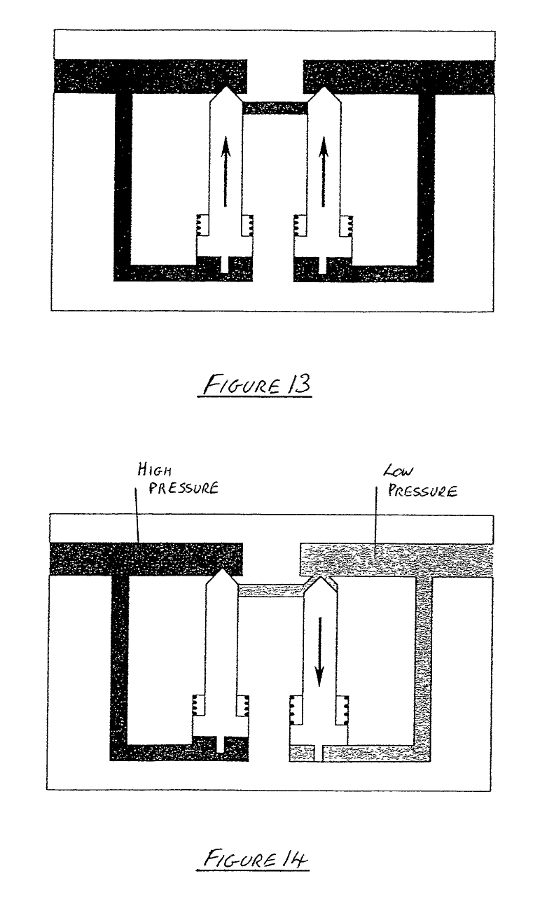

The valve block 107 and its operation are illustrated in more detail in FIGS. 11 to 15. In FIG. 11 the valve block 110 has two entry ports 111, 112. The entry ports 111, 112 are connected via ducts 113, 114 to needles 115, 116. A connecting duct 117 links the entry ports 111 and 112. The springs 118, 119 urge the needles 115, 116 in a downward direction to prevent the heads of the needles 115, 116 from blocking the entry to the connecting duct 117. The ducts and entry ports are filled with oil, the oil being free to move along the hydraulic line 105, 106 and into the hydraulic cylinders 103, 104.

When both of the piston rods 101, 102 are above a surface, the oil pressure within the apparatus is low and because oil is free to move between ports 111 and 112 upward pressure on one of the piston rods 101 causes oil to flow from the hydraulic cylinder 103 through the hydraulic lines 105, 106 via the valve block 107 to hydraulic cylinder 104, the increased volume of liquid in the hydraulic cylinder 104 causing downward motion of the piston rod 102. When upward pressure is applied to both piston rods 101 and 102 simultaneously however, as shown in FIG. 13 the pressure of the oil within the system increases. Because the surface area of the base of the needles 115 and 116 is greater than at the head of the needles 115, 116 the upward force on each of these needles 115, 116 is greater than the downward force with the result that they are urged upwards against the tension in the springs 118, 119 until the heads of the needles 115, 116 close the entry gap between ports 111, 112 and connecting duct 117. As oil is no longer able to flow in either direction the piston rods are unable to move and their relative heights are locked into position.

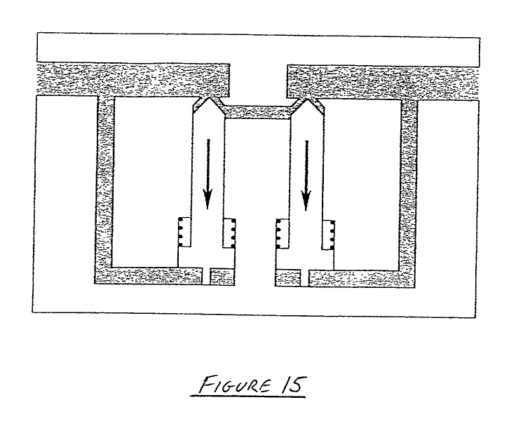

If upward pressure is removed from one of the piston rods, for example the piston rod 101 then the pressure of the oil in the portion of the valve block to which the piston rod is connected drops as shown in FIG. 14. The needle 116 is urged by means of the spring 119 in a downward direction thus unblocking the connection between the entry port 112 and the connecting duct 117. Whilst pressure is maintained on the other piston rod 102 however, the oil pressure within the valve block remains such that the needle 115 continues to block the connection between entry port 111 and the connecting duct 117. The piston rod 102 is therefore maintained and locked into position. Furthermore, due to lack of flow of hydraulic oil through the system, piston rod 101 is likewise fixed into position. Once both piston rods 101, 102 are lifted off the surface the pressure within the hydraulic system drops on both sides of the valve block 110. The needle 115 is thus urged downwardly by the spring 118 with the result that hydraulic oil can flow freely between entry port 111 and connecting duct 117 as shown in FIG. 15. The components within the valve block 110, are now in the same configuration as illustrated in FIG. 12, and the piston rods are thus free to move.

Alternatively or additionally the apparatus can comprise pressure sensing means which, when the pressure of the hydraulic fluid rises above a pre-set level, close a valve to prevent fluid flow.

The apparatus can be provided with an override to temporarily release the locking mechanism when the operator so desires. The case of the mechanical locking element illustrated in FIG. 8, the manual override acts to rotate the locking element to align the offset central hole with the locking rod, the support legs and connecting means thus being able to move freely.

The safety lock may also be incorporated as an additional safety feature, the safety lock fixing the support legs to the appropriate relative position. The safety lock acts to maintain the locking element in frictional engagement with the locking rod.

Where the locking means involves a hydraulic system, such as is described in this document the safety lock can act to prevent flow of hydraulic fluid between two support members. In this case the volume of fluid on either side of the safety lock prevents movement of the support members.

In a further embodiment of the invention a mechanical locking means of the type described herein can be connected to the support legs by means of a hydraulically operated connection. The locking means can for example be engaged and disengaged by means of a piston incorporated as part of the hydraulic connection means. Alternatively, mechanical connection means of the type described herein can be used in conjunction with a hydraulic locking mechanism also described herein.

The invention as detailed herein can be employed to stabilise devices for use in a broad area of industry. The following list is intended to be indicative of those uses and is not intended to be limiting. The apparatus can be formed integral with a particular device or removable. In addition, more than one individual stabilising apparatus can be used for a particular device. The apparatus thus finds application in respect of ladders, stepladders, walking frames, small rigid steps—such as for use in kitchens, libraries, offices, coaches, caravans etc.—airport steps, and both mobile and static scaffolding towers. It can also be used to stabilise industrial or D.I.Y. equipment such as workbenches, planers, saws as well as leisure or training accessories such as wooden horses, benches, exercise bikes, rowing machines, and climbing frames. Supports for cameras, binoculars or telescopes could include an extra leg, which would then lower their centre of gravity and make them more stable.

The apparatus can also be used to support larger, heavier industrial devices and structures such as mobile generators, support legs for commercial trailers and oil rigs. It can also find use in stabilising axles in vehicles, for example the front axles of backhoe loaders and tractors with front loaders. The latter use can be particularly addressed by the use of a hydraulic system.

It will of course be understood that the invention is not limited to the specific details described herein, which are given by way of example only, and that various modifications and alterations are possible without departing from the scope of the invention.

1. A device for stabilising a structure, the device comprising a plurality of support members wherein at least one pair of support members is adjustable in length and connected together by linkages which are operable to releasably engage a locking means to adjust the relative effective length of said support members.

2. A device for stabilising a structure according to claim 1, wherein each of the at least one pair of support members are moveable along their longitudinal axes to alter their effective length.

3. A device for stabilising a structure according to claim 1, wherein each pair of connected support members is so connected that motion of one member of the pair along its longitudinal axis to reduce/increase its effective length, causes corresponding motion of the other member to respectively increase/reduce its effective length.

4. A device for stabilising a structure according to claim 1, wherein the or each linkage comprises one or more pivotally linked arms.

5. A device for stabilising a structure according to claim 1, wherein the locking means is actuated by upward pressure on either one of the at least one pair of support members.

6. A device for stabilising a structure according to claim 1, wherein the locking means operably engages a locking bar disposed between said at least one pair of support members.

7. A device for stabilising a structure according to claim 6, wherein the locking means comprises a locking member in pivotal relationship with the locking bar the locking member engaging said bar in locked relation upon rotation about the pivotal axis.

8. A device for stabilising a structure according to claim 7, wherein engagement of the locking means causes a frictional force between the locking member and the locking bar to prevent motion of the locking member relative to the locking bar.

9. A device for stabilising a structure according to claim 8, wherein the locking bar has a circular cross-section.

10. A device for stabilising a structure according to claim 7, wherein frictional engagement between the locking member and the locking bar is caused by rotation of the locking member about an angle substantially perpendicular to that of the locking bar, the force causing rotation being applied by the linkages.

11. A device for stabilising a structure according to claim 7, wherein the locking member includes an aperture adapted to accommodate the locking bar, the aperture having a longitudinal axis which in a locking position is positioned at an angle to a corresponding longitudinal axis of the locking bar.

12. A device for stabilising a structure according to claim 11, wherein in a release position, the longitudinal axis of the aperture is substantially parallel to the locking bar and has a cross-section complementary to that of said locking bar.

13. A device for stabilising a structure according to claim 7, wherein linkages are coupled by a tensioning member, which biases the linkages to resist frictional engagement between the locking member and the locking bar

14. A device for stabilising a structure according to claim 1, wherein the linkages comprise ducts carrying a locking means actuating fluid.

15. A device for stabilising a structure according to claim 14, wherein the locking means comprises one or more independent valves each operable to prevent the flow of hydraulic fluid within each fluid linkages.

16. A device for stabilising a structure according to claim 15, wherein the locking means comprises two valves.

17. A device for stabilising a structure according to claims 15, wherein the or each valve moves from an open position to a closed position when the pressure of the hydraulic fluid within the linkages reaches a pre-set value.

18. A device for stabilising a structure according to claim 17, wherein the pre-set value is governed by a resilient member biased towards keeping the valve open.

19. A device for stabilising a structure according to claim 18, wherein the resilient member is a spring.

20. A device for stabilising a structure according to claim 1, wherein the device further comprises a second locking means operable to fix releasably the support members.

21. A device for stabilising a structure according to claim 1, wherein the apparatus comprises an override mechanism operable to prevent the locking means from operating.

22. A device substantially as herein described with reference to and as illustrated in the accompanying drawings.

23. A structure incorporating a stabilising device, the device comprising a plurality of support members wherein at least one pair of support members is adjustable in length and connected together by linkages which are operable to releasably engage a locking means to adjust the relative effective length of said support members.

24. A structure according to claim 23, wherein the device is integral with the structure.

25. A structure substantially as herein described with reference to and as illustrated in the accompanying drawings.
